(19) United States
(12) Patent Application Publication
(10) Pub. No.: US 2005/0080669 A1
(43) Pub. Date: Apr. 14, 2005

(54) Cross-selling in standalone sales systems

(75) Inventor: Xiao Zhang, Austin, TX (US)

Correspondence Address: Grant A. Johnson;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/684,125

(22) Filed: Oct. 10, 2003

(51) Int. Cl. G06F 17/60

(52) U.S. Cl. 705/14; 705/26

(57) ABSTRACT

A method and apparatus for cross-selling products based on a system for sale to a customer. One embodiment provides a method including, for each selection by a user of a product from a product information source, receiving an order representing a state of a system based on the user selections; for each order, determining whether the order qualifies for one or more cross-sell products; and if so, presenting the one or more cross-sell products to the user, wherein each of the one or more cross-sell products presented to the user is offered at a discount based on the state of the system.

### BACKGROUND OF THE INVENTION

1. Field of the Invention

The present invention generally relates to a method and system for identifying products available for sale based on a configured order.

2. Description of the Related Art

Providers of high-end computer systems typically use a highly complex configuration system to configure a computer system to a customer's specifications. The configuration system includes a user interface that provides access to products data. Through the user interface, an operator selects a base system (e.g., a server model) and is then presented with configurable options which may be selected to be added to the selected base system. For a given set of operator selections, the configuration system determines whether the selections define a valid configured system. That is, the configuration system determines whether the operator selections are compatible and complete. If so, the configuration process is complete and, in some cases, additional steps such as, configuration validation, availability check, and the like are performed before the configured system is put into the order processing system.

Conventional configuration systems for high-end computer systems are highly complex. A configured system output by a configuration system represents a valid state the determination of which depends upon a well-defined set of validation rules and product data. Accordingly, these configuration systems are standalone systems, unlike the typical internet shopping sites. In addition, the underlying product database accessed by configuration systems cannot be arbitrarily updated without impacting the operability of the configuration system.

It is also currently possible for users to purchase computers online via the Internet. With a Web browser a user may view the complete product line of a given vendor. The user may select a base computer system and then be presented with a plurality of selectable options for the base computer system. For example, a user may select a particular model of a laptop computer and then select the amount of memory, amount of hard disk storage and peripherals appropriate to the laptop computer. However, each of the selectable options has already been predetermined to be appropriate for the given laptop computer and the particular manner in which the selected options will be integrated with the laptop computer is known a priori. Thus, while online purchase system give the appearance of providing users the flexibility to design their own systems, the users are, in fact, forced to elect from a very limited set of options from predefined option menus. Every permutation is known and predetermined. At the end of the selection process, the user has merely selected a particular instance of a predefined computer. It is therefore impossible for users to make selections that result in ordering an invalid system.

The simplicity of interactive online purchase systems allow such systems to offer functionality which the complexity of standalone high-end configuration systems does not permit. In particular, online purchase systems can continuously update their product databases without changing the overlying applications. This allows online purchase systems to employ desirable real-time or near real-time marketing strategies such as presenting the user with promotional or cross-sell products. For example, a given laptop computer may be offered with a free memory upgrade for a limited period of time. As another example, buying one computer component may qualify the user for another computer component at a discount. Currently, such product offerings and other marketing strategies are not possible using standalone high-end configuration systems.

Therefore, there is a need for methods and systems for providing additional product information in high-end configuration systems.

### SUMMARY OF THE INVENTION

The present invention generally provides for cross-selling products based on a system for sale to a customer.

One embodiment provides a computer-implemented method of cross-selling products based on a system for sale to a customer. The method includes, for each selection by a user of a product from a product information source, receiving an order representing a state of a system based on the user selections; for each order, determining whether the order qualifies for one or more cross-sell products; and if so, presenting the one or more cross-sell products to the user, wherein each of the one or more cross-sell products presented to the user is offered at a discount based on the state of the system.

Another embodiment of a computer-implemented method of cross-selling products based on a system for sale to a customer includes receiving, from a user, product selections defining the system; configuring the product selections to represent a configured state of the system based on the product selections; for each product selection, outputting an order representing the configured state of the system; and for each order, determining whether the order qualifies for one or more cross-sell products; and if so, presenting the one or more cross-sell products to the user, wherein each of the one or more cross-sell products presented to the user is offered at a discount based on the state of the system.

Yet another embodiment provides a computer readable medium containing a program which, when executed, performs an operation for cross-selling products based on a system for sale to a customer. The operation includes iteratively receiving an order representing a state of a system based on selections by a user; for each iterative order, applying matching logic to determine whether the order qualifies for one or more cross-sell products; and if the order qualifies, presenting the one or more cross-sell products to the user, wherein each of the one or more cross-sell products presented to the user is offered at a discount based on the state of the system.

Still another embodiment provides a sales system for configuring a computer system for sale to a customer. The sales system includes (a) a source of product information for a plurality of products to create the computer system; (b) a source of cross-sell product information for a plurality of cross-sell products each being related to a configured state of the computer system; (c) a cross-sell analyzer; and (d) a pricing engine. The cross-sell analyzer is configured to: iteratively take as input configured orders, each representing the configured state of the computer system based on user selections from at least the source of product information; and for each order, apply matching logic to determine whether the order qualifies for one or more of the plurality of cross-sell products; and if the order qualifies, presenting the one or more qualifying cross-sell products to the user, whereby the user avoids a burden of manually identifying the one or more qualifying cross-sell products. The pricing engine is configured to calculate a price of the computer system in the configured state.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a high-level diagram of a configuration and sales system in which aspects of the present invention may be implemented.

FIG. 2 is an exemplary flow diagram illustrating one embodiment of identifying and presenting additional products for a configured system.

FIG. 3 is one embodiment of a user interface screen illustrating generic configuration tool capabilities, according to one embodiment of the present invention.

FIG. 4 is one embodiment of a user interface screen illustrating a messages tab in a generic configuration tool user interface screen, according to one embodiment of the present invention.

FIG. 5 is one embodiment of a user interface screen illustrating selection and configuration of a product, according to one embodiment of the present invention.

FIG. 6 is one embodiment of a user interface screen illustrating a diagram tab in a generic configuration tool user interface screen, according to one embodiment of the present invention.

FIG. 7 is one embodiment of a user interface screen illustrating a messages tab containing a cross-sell message, according to one embodiment of the present invention.

FIG. 8 is one embodiment of a user interface screen illustrating a messages tab containing a cross-sell message and a list of qualified cross-sell products, according to one embodiment of the present invention.

FIG. 9 is one embodiment of a user interface screen illustrating a detailed cross-sell text message, according to one embodiment of the present invention.

FIG. 10 is one embodiment of a user interface screen illustrating the selection of a cross-sell product, according to one embodiment of the present invention.

FIG. 11 is one embodiment of a user interface screen illustrating a configuration wizard for a cross-sell product, according to one embodiment of the present invention.

FIG. 12 is one embodiment of a user interface screen illustrating a modified cross-sell products list, according to one embodiment of the present invention.

FIG. 13 is one embodiment of a user interface screen illustrating a diagram pane showing the additional selected products, according to one embodiment of the present invention.

FIG. 14 is one embodiment of a user interface screen illustrating a diagram pane showing the final configured system, according to one embodiment of the present invention.

FIG. 15 is one embodiment of a user interface screen illustrating an alternative way of displaying cross-sell products information, according to one embodiment of the present invention.

FIG. 16 is one embodiment of a user interface screen illustrating another alternative way of displaying cross-sell products information, according to one embodiment of the present invention.

FIG. 17 is another embodiment of a user interface screen illustrating yet another alternative way of displaying cross-sell products information.

### DETAILED DESCRIPTION OF THE PREFERRED EMBODIMENTS

The present invention is generally directed to a system, method, and article of manufacture for providing additional products information in high-end configuration systems. In particular, an analyzer analyzes a currently configured system, and based on cross-sell products information and predefined cross-sell conditions, determines whether there are any cross-sell products available that may be added to the current system. These identified cross-sell products are presented to a user, who decides whether or not to make additional selection.

For purposes of illustration, aspects of the invention described herein are specifically directed to high-end configurators used in configuring computer systems for sale. However, it is understood that the invention includes, extends to, encompasses, and/or applies to any other sales system. For example, one other sales system which may benefit from the invention includes systems for configurating down-hole tools in oil well applications. Persons skilled in the art will recognize other environments which may benefit from aspects of the invention.

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

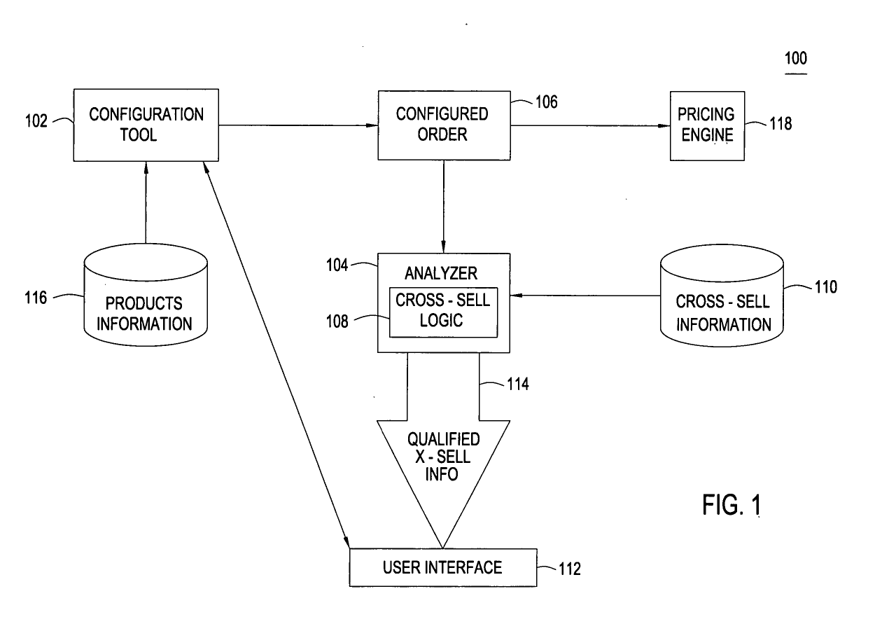

Referring now to FIG. 1, a configuration and sales system 100 is shown. Generally, the system 100 includes a system configuration tool 102 and an analyzer 104. As shown in FIG. 1, the system 100 is not intended to suggest or necessitate any particular architecture. Thus, it is contemplated that the configuration tool 102 and the analyzer 104 reside on the same system, or on separate systems. Further, although shown as singular entities, in practice the configuration tool 102 and the analyzer 104 may be implemented as a plurality of software and/or hardware components collectively configured to perform various functions, including those described herein.

In one embodiment, the configuration tool 102 is a constraint-based configuration system that uses a structural hierarchy model. The configuration tool may configure a system by identifying the component or resource requirements, constraints imposed on or by the components or resources identified, and the structural aspects of the system. A constraint-based configuration system applies constraints on the use of components or resources in a configuration. For example, a 128 MB, 567 MHz Level 3 cache memory can only be put into processors that not only provide the cache memory slots for 567 MHz speed, but also are compatible with the particular Level 3 cache memory ordered. The 567 MHz cache memory slot resource and processor compatibility are constraints for the Level 3 cache memory. The structural model provides the ability to identify logical data-type and physical interconnections between different elements and establish connections between them. For instance a model element can be contained in, or constraint by, another model element, and the information between them can be passed through the structural model hierarchy for configuration purposes. For example, if an external storage tape needs to be connected to a server, the model can check whether the external storage adapters contained in the server are the correct type that would allow the tape to be connected.

In an embodiment of the present invention, the configuration tool 102 provides a user access to available product selections from products information source 116. The available selections are displayed, and selected from, a user interface 112. In addition to data representing the available selections from which a user may choose, the products information source 116 may also include the necessary logic for these data to interact with each other and respond to different user selections. As previously described, the configuration tool processes the selections and determines whether the products chosen are compatible and complete to be a valid order, by running them through the validation logic/process.

In operation, the configuration tool 102 presents the available product selections to a user who then makes desired selections via the user interface 112. The result of each user selection is a configured order 106, produced by the configuration tool 102. Thus, the configuration tool 102 may iteratively output a configured order 106 in response to each user selection of a product. The configured order 106 represents a state of the configured system during the user selection process and contains a list of products selected and used in the configuration of the current system. Any given configured order, however, may not be valid. At least in one embodiment, validation is performed in response to an explicit user command input via the user interface 112. In response to the validation request, the tool 102 determines, for the given set of user selections, whether the selections are compatible and result in a valid configured system. Upon validating the configuration, the final configured system is in a single valid state. That is all the necessary parts (i.e., hardware, software, services, etc) have been automatically generated and validated.

In one embodiment, the configured order 106 is input to the analyzer 104. The analyzer 104 is configured to determine availability of additional compatible products by examining the configured order 106 and a cross-sell information source 110. Like the products information source accessible to the configuration tool 102, the cross-sell information source 110 includes data and related logic. In one embodiment, the cross-sell information source 110 contains cross-sell products that may be offered to customers who have configured a system, or are currently configuring a system, using the configuration tool 102. These products are termed “cross-sell” products because they are offered based on selection of a base system made through the configuration tool 102. Typically, the cross-sell products are of limited/restricted availability. For example, cross-sell products may be promotional and only be offered for a limited time. Thus, the cross-sell products may include new products or existing products for which a provider wishes to induce more sales. In any case, the cross-sell products may be offered at a discounted price (or be entirely free), but only when purchased along with another specific product.

The cross-sell information source 110 does not necessarily have to be a separate file from the products information source 116. Accordingly in one embodiment, the cross-sell information source 110 and the products information source 116 may be part of the same file. Additionally, the cross-sell information source 110 may contain a real time (i.e., up to the minute) list of cross-sell products, in one embodiment. This functionality may be provided when there is a real time data source from which the cross-sell information source may be replicated at any given instance.

The analyzer 104 contains a set of predefined cross-sell logic 108. The logic 108 govern whether or not, for a given configured order 106 input to the analyzer 104, there are any products in the cross-sell information source 110 that could be offered to the customer ordering the configured system represented in the configured order 106. Any cross-sell products identified by the analyzer 104 as satisfying the logic 108 for a given configured order 106 are referred to as qualified cross-sell products 114. In one embodiment, the qualified cross-sell products 114 are displayed to the user through the user interface 112. Embodiments of the user interface 112 are described below.

At any time during configuration of a system (whether validated or not), a user may determine the price of selected components and the configured system by invoking a pricing engine 118. The pricing engine 118 includes pricing files that contain pricing data for corresponding products in the products information source 116 and the cross-sell information source 110. Once an order is configured (although not necessarily validated), the selected products list contained in the configured order 106 is received by the pricing engine. The pricing engine then, accesses the price data for the products in the order and calculates the final price.

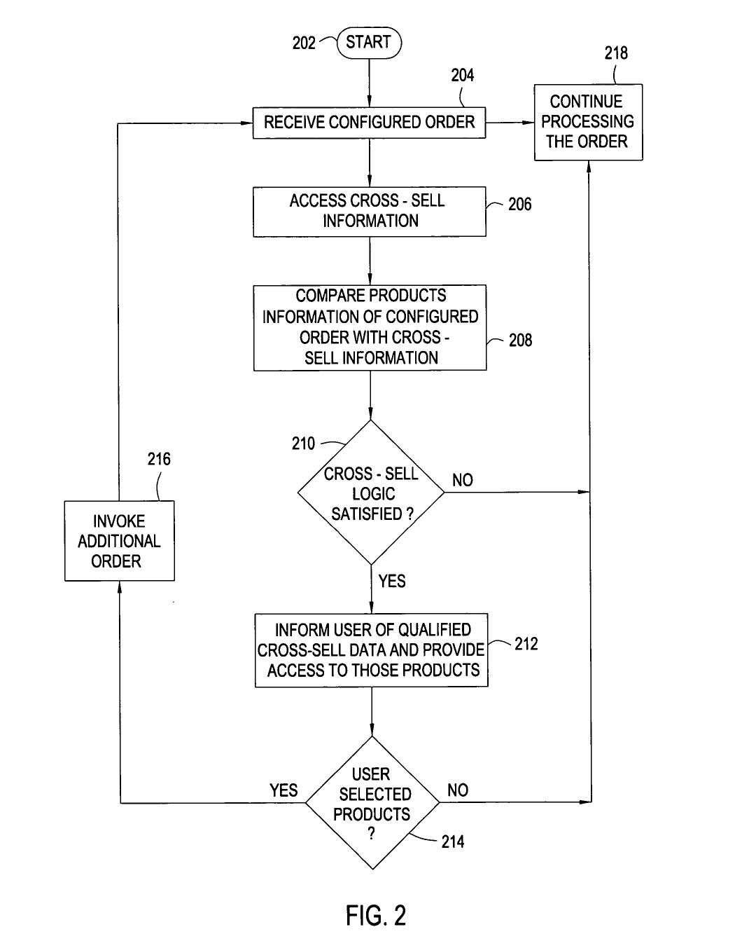

FIG. 2 illustrates an exemplary method 200 for providing cross-sell products information for a configured system. In one embodiment, the method 200 is implemented by the analyzer 104. The method 200 may be entered, for example, upon making changes (e.g., selecting additional products) to the configured system. The configured system at any given time is represented by the configured order 106, which is output by the configuration tool 102. The analyzer 104 receives the configured order 106 from the configuration tool 102 (step 204). The analyzer then, accesses the cross-sell information source 110 (step 206) and compares the products information obtained from the configured order with the products available in the cross-sell information source (step 208). Based on the given sets of data, the analyzer 104 applies the cross-sell logic 108 to determine whether or not any cross-sell products (i.e., qualified cross-sell products 114) are available to the user (step 210). In another words, for the given configured system (as represented by the configured order 106), the analyzer 104 determines whether the user has qualified for a discount on one or more qualified cross-sell products 114.

If the analyzer determines that there are products that satisfy the cross-sell logic (step 210), the user is informed through the user interface 112 (step 212). For instance, the user interface 112 may simply display a message in the current configuration screen or list the qualified cross-sell products in a configuration screen. In any case, the user is given an indication of what the qualified cross-sell products 114 are and may also be given any related terms and conditions (e.g., the amount of the discount, a limit on the number of qualifying products which may be purchased at the discount, etc.). If the user decides to order a qualified cross-sell product (step 214), the additional order is processed by invoking an appropriate interface (step 216). When the user does not select any additional products or cross-sell conditions are not met (i.e., the analyzer does not identify any qualified cross-sell products 114), the order is processed as normal (step 218).

This process may be repeated every time the user selects an additional product or service to be added to the configured system. That is, for each selection, and the resulting configured order 106, the analyzer may take the configured order 106 as input and identify any qualifying cross-sell products. In this way, users can be notified of cross-sell products in a manner that does not disturb the state of the configuration tool 102. This is so because the analyzer 104 does not directly interfere with the configured order 106. Instead, the analyzer 104 merely alerts the user to possible cross-sell opportunities based on a given configured order 106. The qualifying cross-sell products identified by the analyzer 104 are already present in the product information source accessed by the configuration tool 102. Thus, any user selection of a qualifying cross-sell product appears to the tool to be nothing more than another selection. The fact that the selection was made as a result of the user having been notified of a discount (or other sales advantage) is completely transparent to the configuration tool 102.

As noted above, user interaction with the system 100 is facilitated by the interface 112. In one embodiment, the interface 112 is a graphical user interface (GUI) comprising a number of screens that enable the user to configure a system. The user steps taken with respect to the interface 112 during a configuration process may include, but are not limited to, making selections from a list of available products and services, configuring and validating the system based on the selections made, and choosing additional qualified cross-sell products after they have been identified. Following is an illustration of such steps with respect to representative screens of the interface 112.

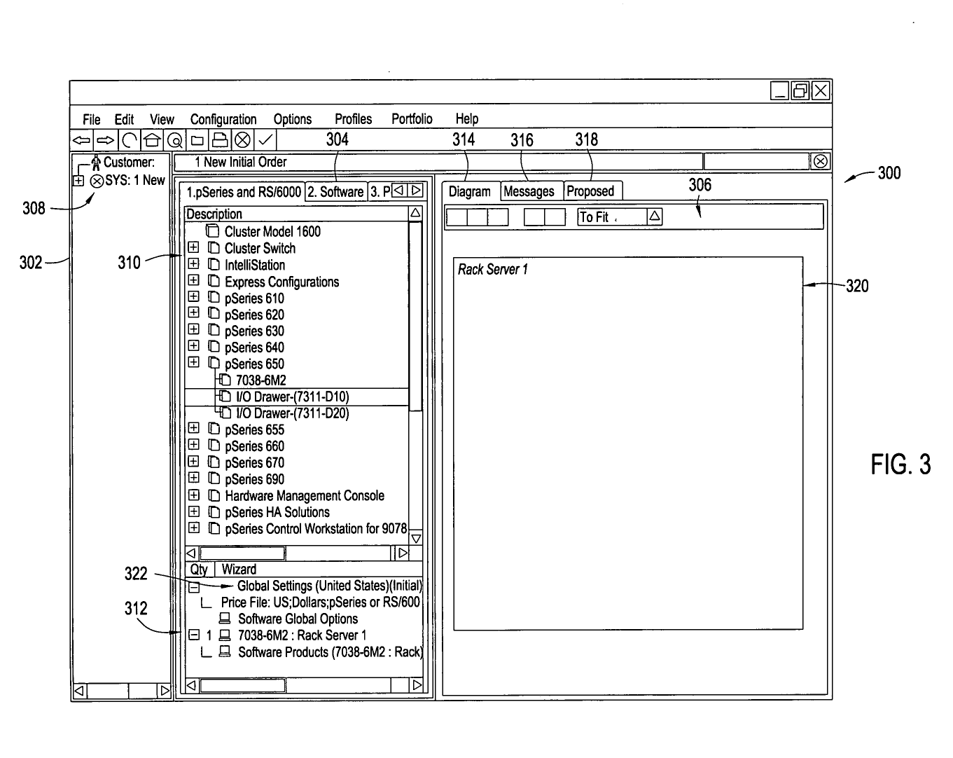

FIGS. 3-14 show exemplary user interface 112 screens that may be utilized in selecting products for and configuring a system according to one embodiment of the present invention. For example, FIG. 3 illustrates an exemplary GUI screen 300 through which a user can select configurable products for a previously chosen base system. The GUI screen 300 illustratively includes three frames. A first frame 302 presents a list of base systems a customer has ordered, showing whether or not those systems are in a valid state. For example, a red cross 308, signals that the base system, SYS: 1 New, has not yet been validated. A second frame 304 is divided between two sections. A top section 310 includes various tabs that represent the different kinds of components available for the base system 308. By clicking on each of these tabs, the user may be presented with a comprehensive list of products available. A bottom section 312 shows a list of products that have already been selected. For example, the frame 312 shows that a rack server 7038-6M2 has previously been selected by the customer. Additionally, the bottom section 312 contains a Global Settings object 322. The object 322 represents the geographic context in which a system is being configured For example, as illustrated, the Global Settings object 322 is set to the “United States”, since the product is being configured and sold in the United States. If the system were being configured in a Japan, for example, the object 322 would be set to Japan. For a given geographic context, the Global Settings object represents the available products, cross-sell products, and/or pricing files that are being used in the current configuration session.

In addition to the functionalities provided by the frame 304 (in the top and bottom sections 310 and 312), a third frame 306 on the right offers three additional tabs. Selection of a diagram tab 314 may show customer orders in a diagram pane diagram pane 320. The diagram pane 320 shows a top-level graphical representation of the ordered system. The details of the underlying structure of the ordered system, however, may be omitted from the diagram pane 320. Selection of a proposed tab 318 may present a list of products selected and their corresponding cost in a textual format. Additionally, selection of a messages tab 316 may provide a list of messages the provider wishes to convey to the customer.

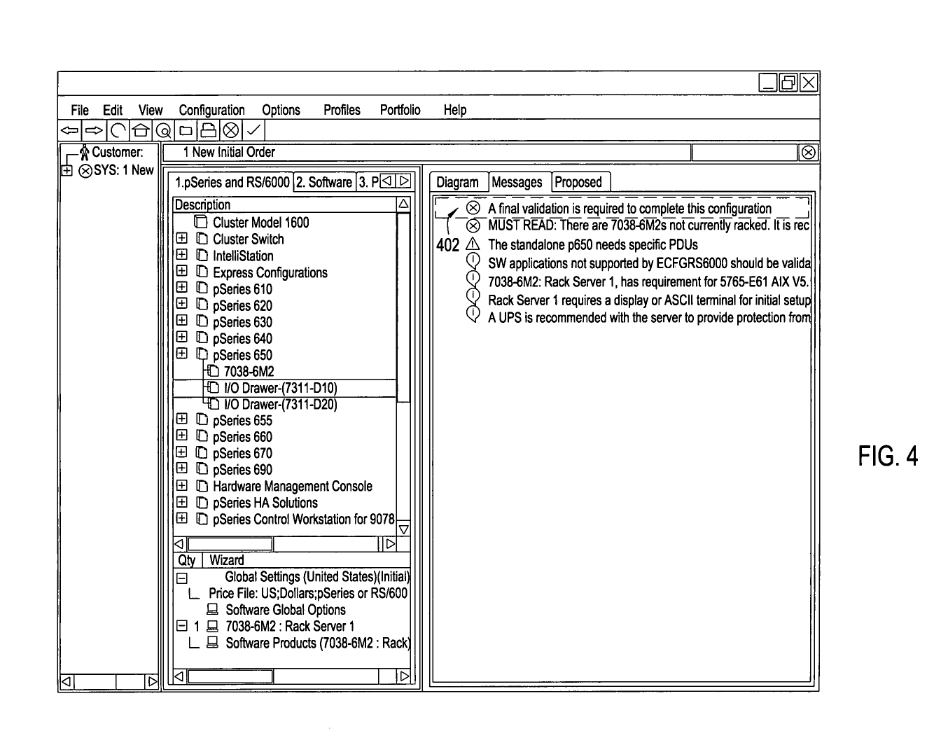

FIG. 4 illustrates representative messages that may be displayed to the user when the messages tab 316 is selected. For example, the messages include a warning 402: “A final validation is required to complete this configuration.” If the analyzer 104 (FIG. 1) determines that qualified cross-sell products exist for the current configuration, a cross-sell message may also be displayed in the message pane, as will be described below.

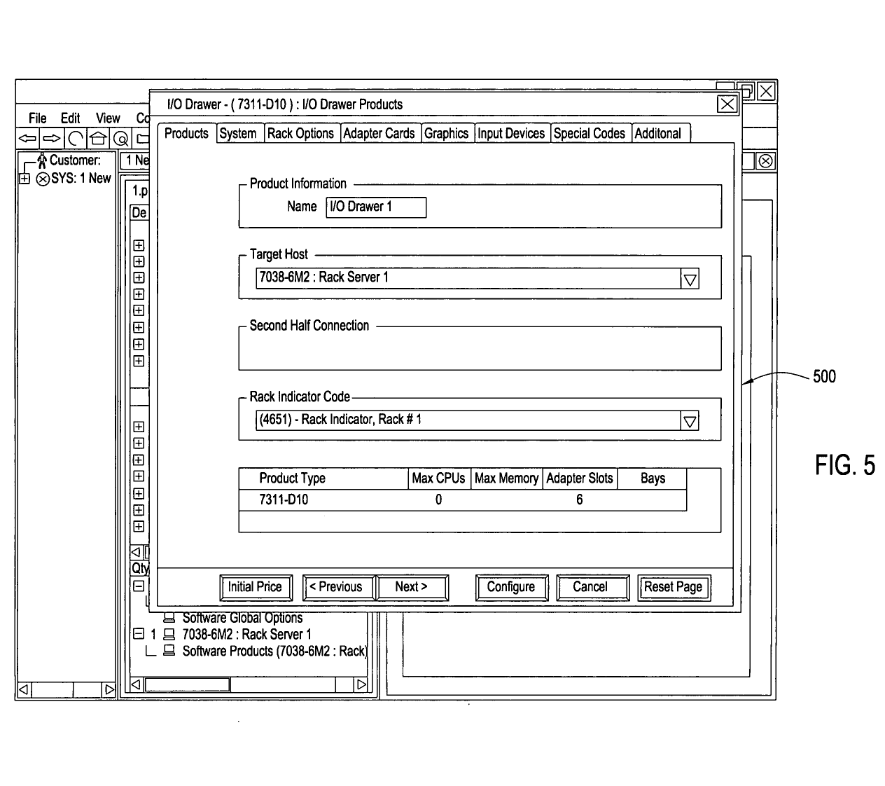

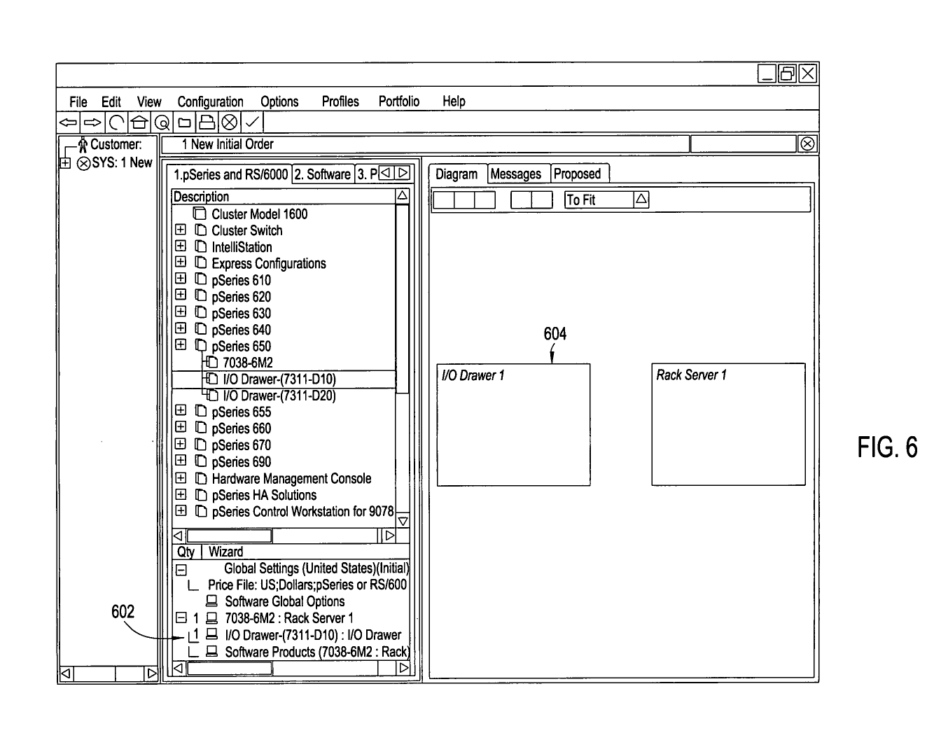

Selecting an additional product from the top section 310 may invoke a corresponding wizard that assists in customizing and configuring an available product. For example, by selecting “I/O Drawer-[7311-D10]” from the “pSeries and RS/6000” tab, a wizard such as the one illustrated in FIG. 5 may be invoked. As shown in an exemplary GUI 500, the user may utilize the wizard to customize the order, configure the system, or cancel the request. FIG. 6 illustrates that after the product has been selected and customized through the wizard, a product object 602 (“I/O Drawer”) is added to the products list in the frame 312. Additionally a graphical element 604 representing the “I/O Drawer” has been added to the diagram pane 320.

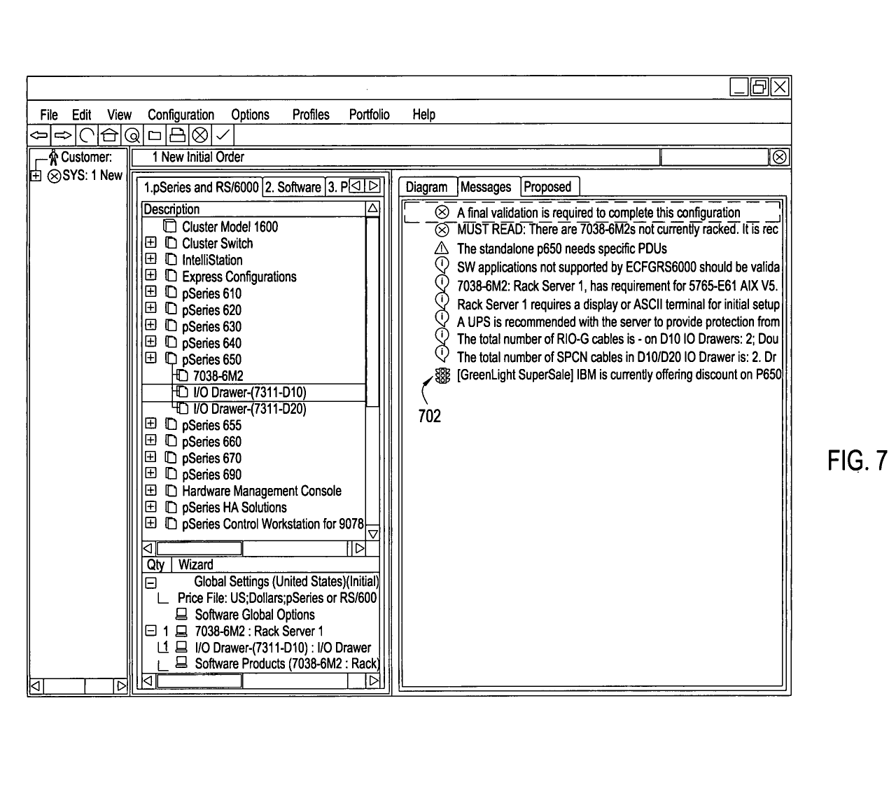

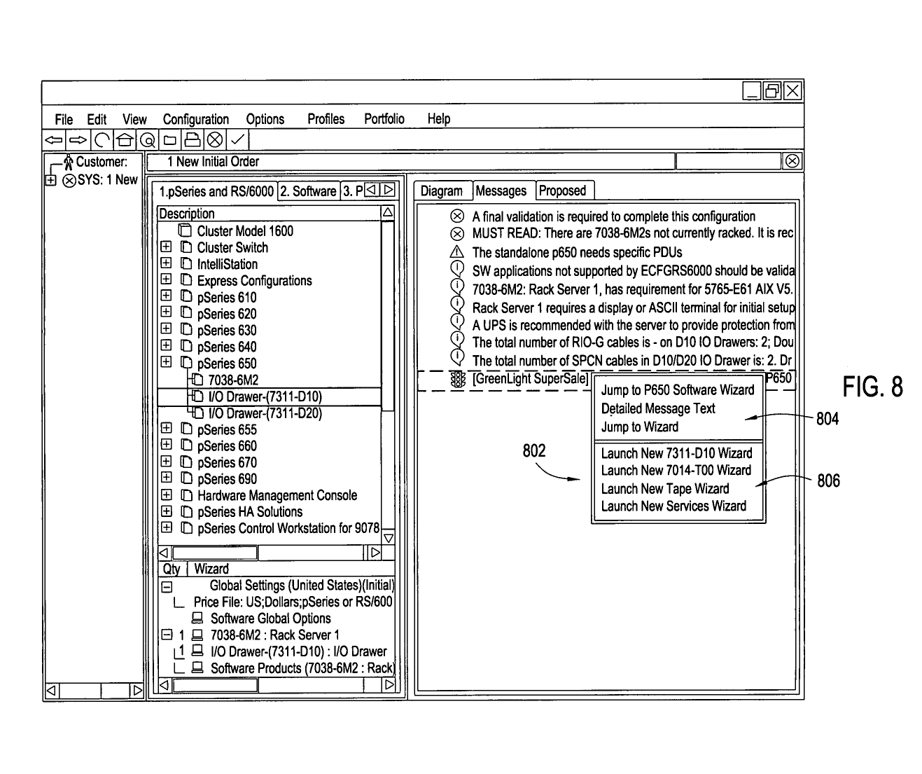

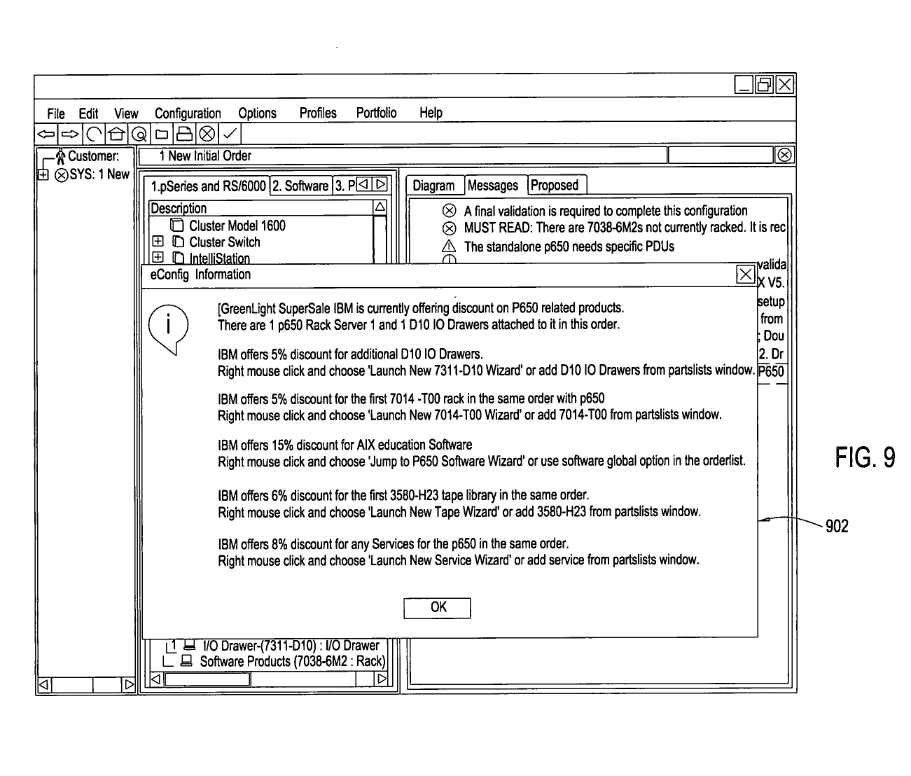

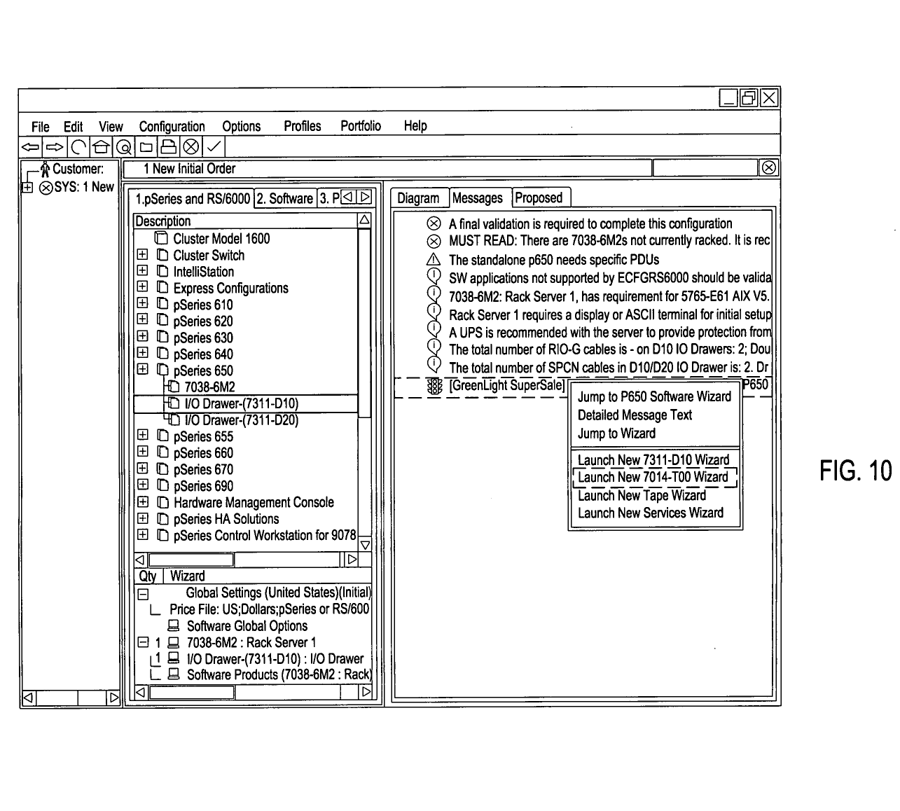

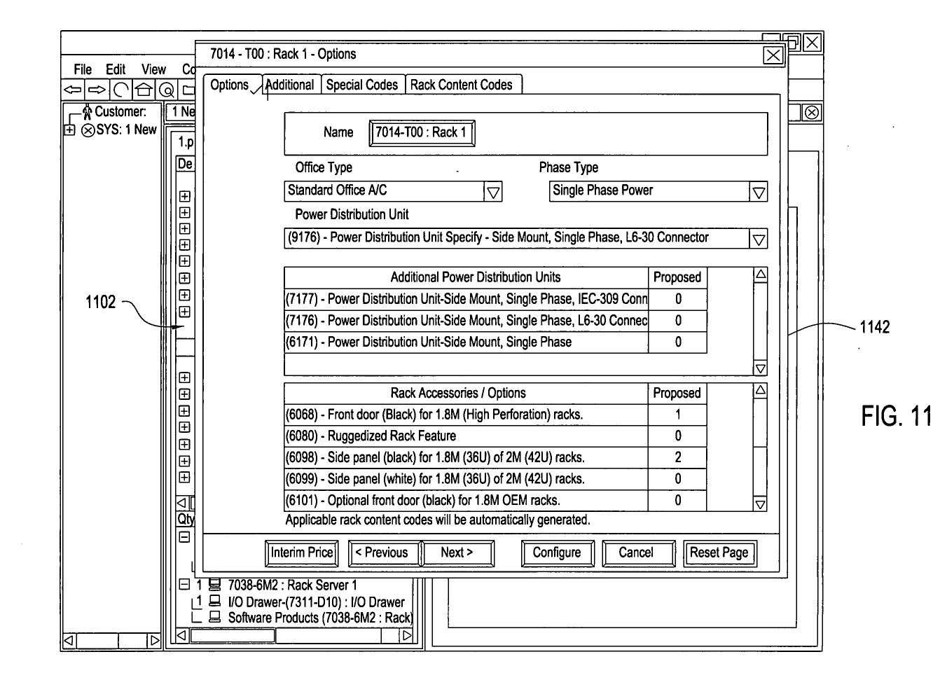

After the product has been added, analyzer 104 examines the updated configured order to determine the availability of qualified cross-sell products for the new configuration. When qualified products are identified, a cross-sell message 702 (illustratively shown as “GreenLight SuperSale”) may be displayed to the user in the message tab 316, as illustrated in FIG. 7. This message 702 provides a notification to the user that qualified cross-sell products are available. To access these products, the user may right-click on the cross-sell message 702. FIG. 8 illustrates a menu 802 that may be displayed upon right-clicking on the message 702. The menu 802 provides a list of all of the available cross-sell products. Generally, the menu 802 provides access to an appropriate wizard for each of the listed cross-sell products. In the illustrative embodiment, the menu 802 is divided into two sections. A top section 804 contains a list of products for which a wizard is already executing in the background, and a bottom section 806 which contains products for which a new wizard must be invoked. For example, the top section 804 includes a “Jump to P650 Software Wizard” selection. This indicates to the user that the P650 Software Wizard is already executing and the user may navigate to the wizard by clicking on the “Jump to P650 Software Wizard” selection. However, rather than proceeding directly to any particular wizard listed on the menu 802, the user may desire to know the details of the corresponding cross-sell products (i.e., under what conditions/terms these cross-sell products are being offered). To this end, the top section 804 includes a functionality to view a “Detailed Message Text.” Upon selecting the “Detailed Message Text” from the menu 802, or double clicking on the cross-sell message 702, a GUI screen 902 is displayed, as illustrated in FIG. 9. The screen 902 may provide a detailed list of the cross-sell products identified, available discounts, and one or more ways to access these cross-sell products. For example, 5% discount is being provided for additional “D10 IO Drawers.” The user is instructed to right click and choose “Launch New 7014-T00 Wizard”, or alternatively select the “D10 IO Drawers” from the partlists window which may be accessible from the frame 310. Having reviewed the information provided by the screen 902, the user may now desire to invoke a particular wizard. FIG. 10 illustrates an example of how the user may directly invoke a cross-sell product's wizard by right clicking on the message 702 and choosing the desired product from the menu 802. For example, selecting “Launch New 7014-TOO Wizard” will invoke the appropriate product's wizard, as illustrated in FIG. 11. The user may customize the new selected product and reconfigure the system through the wizard 1102, as shown in FIG. 11. After the new product has been added and configured, the analyzer again examines the new configured order to determine availability of qualified cross-sell products.

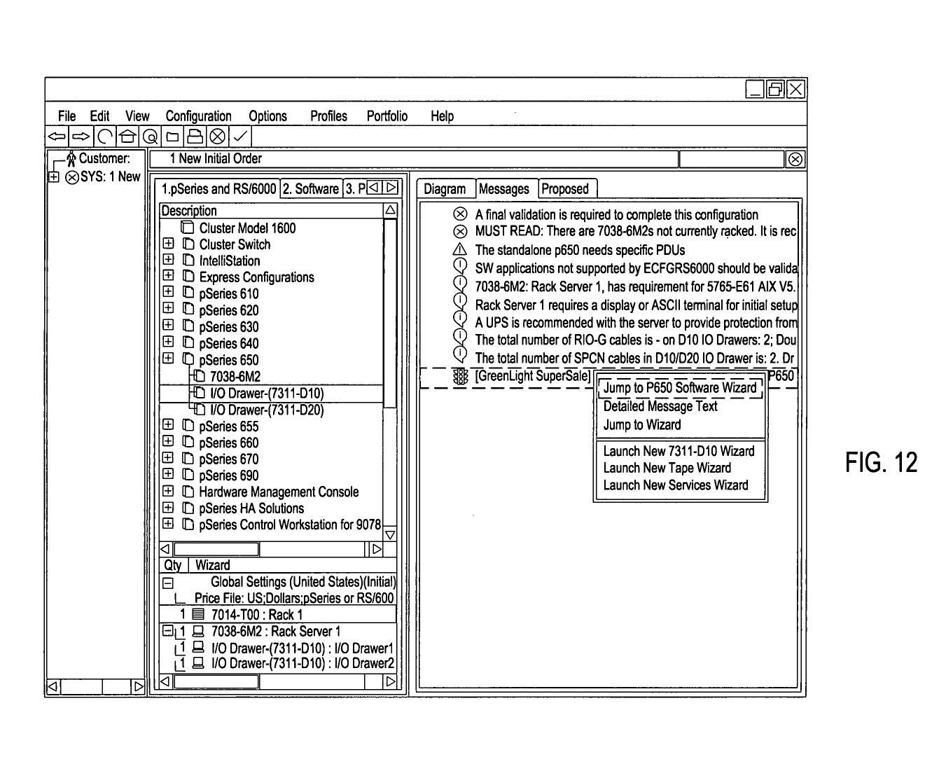

FIG. 12 shows that the new product “7014-T00” has been added to the product's list in the frame 312. As illustrated, the menu 802 has been updated and no longer includes “7014-T00”. This may be because the discounted price is only offered once, so that the customer may only purchase one of the specific product at the discounted price. Of course, the quantity of a given discounted cross-sell product available to a customer for a given configured system may be varied. For example, the products list in the frame 312 indicates that the user has also selected an additional I/O Drawer 7311-D10. However, in this case, this product is still available at the discounted price and is included in the in the bottom section 806 of the menu 802.

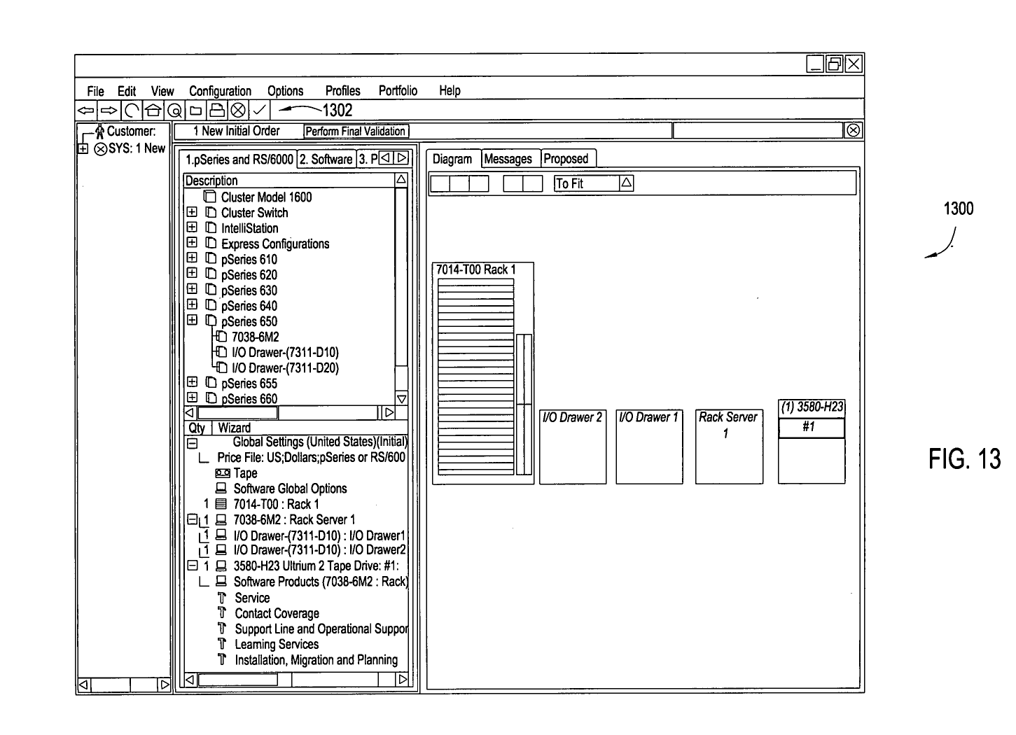

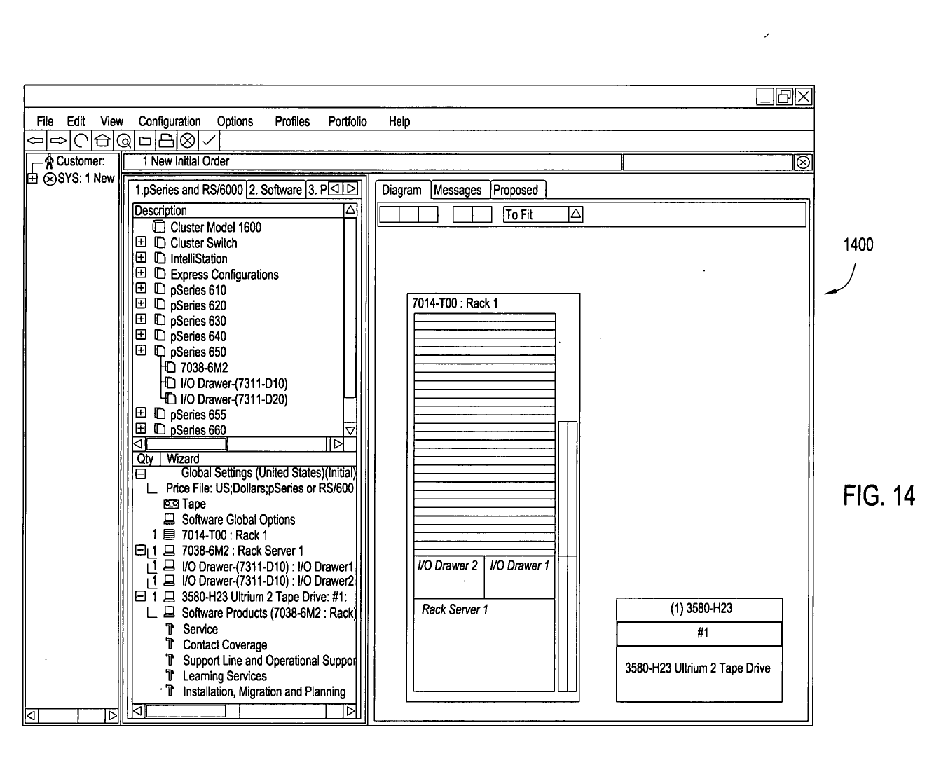

FIG. 13 illustrates the diagram pane 320, after the customer has selected and configured additional products for the system. As shown, a button 1302 (marked by a checkmark) is provided for performing the final validation for the system. By clicking on the button 1302 a final configuration for the system may be performed. FIG. 14 illustrates the final configured system. As illustrated, the different components are now organized and stacked to represent a final valid state.

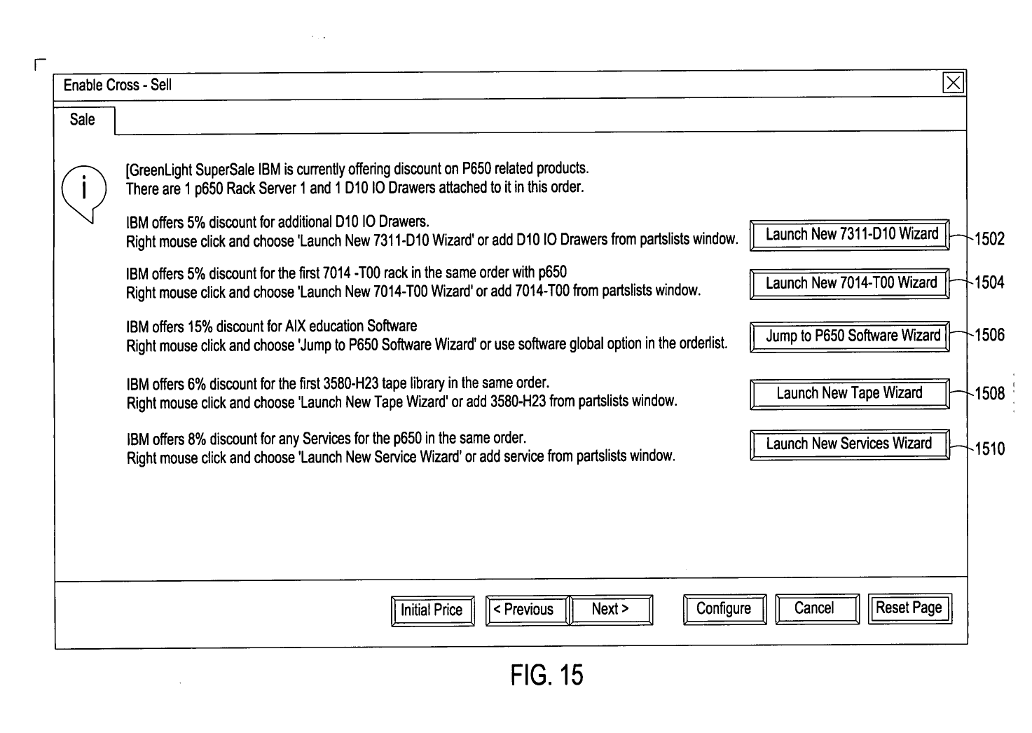

While the GUI screens described herein provide one or more embodiments of the present invention, persons skilled in the art will recognize that the information presented herein can be presented in a variety of other ways while still providing the same or similar results. For example, an alternative embodiment is illustrated in FIG. 15. A GUI screen 1500 may be used to present the users with qualified cross-sell products, detailed text message about the products, and direct access to the appropriate wizard, all at the same time. As illustrated, buttons 1502-1510 provide direct access to the qualified cross-sell products. By clicking on any of these buttons, the specified product will be added to the order and a corresponding configuration wizard is invoked.

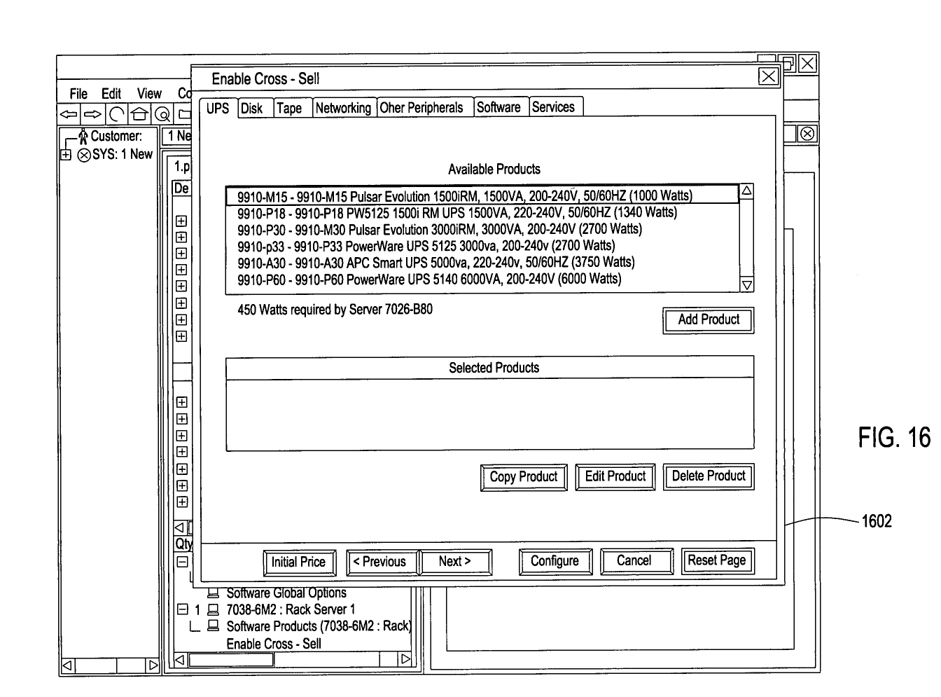

Another alternative embodiment may provide access to the cross-sell products with a single click while enabling the user to run the appropriate wizard from the same interface, as shown in FIG. 16. An exemplary GUI screen 1600 is shown, which may have been accessed with a single click of the Enable Cross-sell object in the frame 312. For the convenience of the user, cross-sell products shown in the screen 1600 are categorized. A corresponding list of cross-sell products in each category may be displayed by selecting the particular category's tab. For example, as illustrated, by choosing the UPS tab 1604, a list of UPS related available cross-sell products is displayed in the available products frame 1606. In particular, FIG. 16 illustrates that the products from each category are accessible from one screen, and the user may highlight a desired product, select it by clicking on the Add Product button 1608 and configure the product from the same screen. The user may also add any number of cross-sell products from the screen 1600 before performing a configuration.

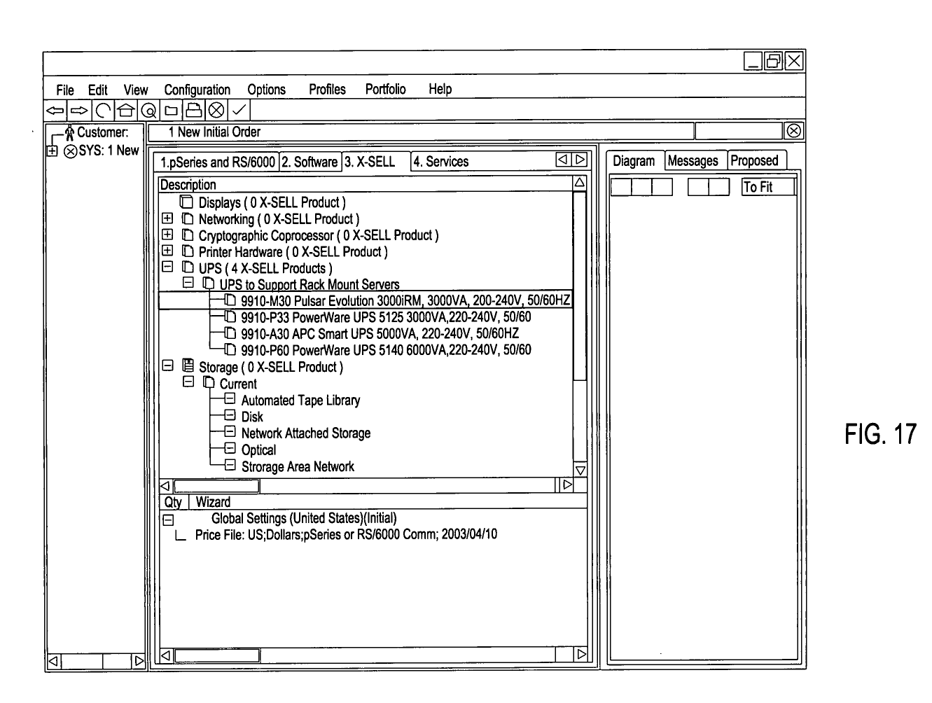

Yet another embodiment for providing a user access to cross-sell data is illustrated in FIG. 17. In particular, the screen 1700 shows a cross-sell tab 1702, which when selected, displays all of the available cross-sell products for a given configuration. A special case is where the user has not made any system selections (i.e., at the beginning of a configuration session). In this case, the cross-sell tab will show the configuration-independent cross-sell products. These are cross-sell products offered to users independent of a particular configured system. This may be advantageous for a provider desiring to promote selected products without tying them to a configured system. Thus, in the screen as shown, the user has made no system selections for configuration and the products shown are the configuration-independent cross-sell products. Illustratively, only the UPS product line has configuration-independent cross-sell products (4 in this example). The other product categories have no configuration-independent cross-sell products. Once the user makes their first selection this screen will be refreshed and cross-sell products specific to the particular configured system will be shown. Thus, additional cross-sell products may be shown for some of the categories. In addition, the four UPS cross-sell products will still be shown. That is, the configuration-independent cross-sell products will continue to be shown throughout the configuration session. As the user continues to make selections, the cross-sell products shown will continue to be updated, but the configuration-independent cross-sell products will always be available for selection, since they are not tied to the particular instance of the configured system.

Various embodiments of the invention provide numerous advantages over the prior art. Some of these advantages are now described. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

In one aspect, the present invention provides a non-web based configuration and sales system for high-end computer systems. Such a system provides users the convenience of knowing about cross-sell products for a given configuration of a computer system, without affecting the underlying configuration. As such, existing configurators can continue to operate without fundamental design changes to the configurator. Instead, the analyzer of the present invention independently determines whether cross-sell products are available for a given configuration. The user can then be notified of any such availability and make selections accordingly. The state of the configurator is unaffected by the operation of the analyzer and subsequent user selections are configured in a conventional manner.

Because the web is not well-suited to support existing complex configuration systems for configuring high-end computers, presently no such system is available online. Accordingly, the present invention is directed at non-web based configuration systems. It is to be noted, however, that embodiments of the invention may be extended to future online configuration systems that configure high-end computers, when and if such systems become available. The present invention may be adopted to perform cross-selling schemes for web-based configuration systems that configure high-end computers, and such a system would be different from present web-based cross-selling schemes because today's systems may only be used for simple products and not complex high-end computers.

In another aspect, the present invention provides 1-click direct access to qualified cross-sell products. Such a system provides users the convenience of accessing the desired product directly. Instead of having to locate the product among a comprehensive list of products information, selecting the desired product, and running a corresponding wizard to configure the additional product, this functionality allows for performing the same process in one easy step that entails clicking on a desired qualified cross-sell product. This creates an efficient and accurate mean of placing additional orders of products, while assuring that the products will be discounted.

In yet another aspect, the invention offers cross-sell functionality in a single sales cycle. The system provides the user with ability to order cross-sell products in a single sales cycle, without a need to finish the configuration, validate the system and then add the desired cross-sell products. This improves efficiency by enabling the user to add additional products before finishing the final configuration. Of course, the users can still perform the validation step prior to making additional selections, if desired, but that is not required.

In yet another aspect, the invention provides a way for customers to acquire cross-sell products for previously purchased systems. Such a system provides functionality for analyzing final configured orders of previously purchased systems, just as it does for a currently pending configured order. The analyzer can analyze a final configured order and determine based on the cross-sell products information source and the cross-sell conditions, whether there is any qualified cross-sell products available for the previously purchased system. This is very advantageous to both customers and providers of high-end computer systems. It provides an easy and efficient way for customers to find and order additional products that are both compatible with the currently owned systems and are promotional. For providers this creates additional sales and revenue.

While the foregoing is directed to embodiments of the present invention, other and further embodiments of the invention may be devised without departing from the basic scope thereof, and the scope thereof is determined by the claims that follow.

1. A computer-implemented method of cross-selling products based on a system for sale to a customer, comprising:
for each selection by a user of a product from a product information source, receiving an order representing a state of a system based on the user selections;
for each order, determining whether the order qualifies for one or more cross-sell products; and
if so, presenting the one or more cross-sell products to the user, wherein each of the one or more cross-sell products presented to the user is offered at a discount based on the state of the system.

2. The method of claim 1, wherein at least one of each order has been processed to ensure that the state of the system is valid.

3. The method of claim 1, wherein at least one of each order has been validated to ensure that the individual products selected by the user from the product information source for the system are compatible and to ensure that the system is properly configured with products necessary for proper operation.

4. The method of claim 1, wherein determining whether the order qualifies for one or more cross-sell products comprises applying matching logic to the order to determine whether the order satisfies predefined conditions.

5. The method of claim 1, further comprising calculating a price of at least one iterative order.

6. The method of claim 1, wherein each of the one or more cross-sell products presented to the user is offered at a discount based on the state of the system.

7. The method of claim 1, wherein presenting the one or more cross-sell products to the user comprises displaying a notification to the user in a graphical user interface.

8. The method of claim 7, wherein, for at least one of the one or more cross-sell products, the notification comprises a selectable graphical element for invoking a configuration wizard adapted to facilitate adding the at least one of the one or more cross-sell products to the system.

9. A computer-implemented method of cross-selling products based on a system for sale to a customer, comprising:
receiving, from a user, product selections defining the system;
configuring the product selections to represent a configured state of the system based on the product selections;
for each product selection, outputting an order representing the configured state of the system; and
for each order, determining whether the order qualifies for one or more cross-sell products; and
if so, presenting the one or more cross-sell products to the user, wherein each of the one or more cross-sell products presented to the user is offered at a discount based on the state of the system.

10. The method of claim 9, wherein, for at least one of the one or more cross-sell products, the notification comprises a selectable graphical element for invoking a configuration wizard adapted to facilitate adding the at least of the one or more cross-sell products to the system.

11. The method of claim 9, wherein determining whether the order qualifies for one or more cross-sell products comprises applying matching logic to the order to determine whether the order satisfies predefined conditions.

12. The method of claim 9, further comprising validating at least one order to ensure that the individual products selected by the user are compatible and to ensure that the system is properly configured with products necessary for proper operation.

13. The method of claim 12, wherein the validating is performed subsequent to determining whether the order qualifies for one or more cross-sell products.

14. The method of claim 9, wherein presenting the one or more cross-sell products to the user comprises displaying a notification to the user in a graphical user interface.

15. The method of claim 14, wherein, for at least one of the one or more cross-sell products, the notification comprises a selectable graphical element for invoking a configuration wizard adapted to facilitate adding the at least one of the one or more cross-sell products to the system.

16. A computer readable medium containing a program which, when executed, performs an operation for cross-selling products based on a system for sale to a customer, the operation comprising:
iteratively receiving an order representing a state of a system based on selections by a user;
for each iterative order, applying matching logic to determine whether the order qualifies for one or more cross-sell products; and
if the order qualifies, presenting the one or more cross-sell products to the user, wherein each of the one or more cross-sell products presented to the user is offered at a discount based on the state of the system.

17. The computer readable medium of claim 16, wherein each iterative order is output by a configuration tool adapted to:
receive, from the user, product selections defining the system;
configure the product selections to represent the state of the system based on the product selections;
for each product selection, output the order representing the state of the system.

18. The computer readable medium of claim 16, wherein at least one iterative order is processed to ensure that the state of the system is valid.

19. The computer readable medium of claim 16, the operation further comprising validating the state of the system to ensure that the individual products selected by the user are compatible and to ensure that the system is properly configured with products necessary for proper operation.

20. The computer readable medium of claim 16, wherein applying matching logic comprises determining whether the order satisfies predefined conditions.

21. The computer readable medium of claim 16, wherein presenting the one or more cross-sell products to the user comprises displaying a notification to the user in a graphical user interface.

22. The computer readable medium of claim 21, wherein, for at least one of the one or more cross-sell products, the notification comprises a selectable graphical element for invoking a configuration wizard adapted to facilitate adding the at least one of the one or more cross-sell products to the system.

23. The computer readable medium of claim 16, the operation further comprising calculating a price of at least one iterative order.

24. A sales system for configuring a computer system for sale to a customer, comprising:
(a) a source of product information for a plurality of products to create the computer system;
(b) a source of cross-sell product information for a plurality of cross-sell products each being related to a configured state of the computer system;
(c) a cross-sell analyzer configured to:
iteratively take as input configured orders, each representing the configured state of the computer system based on user selections from at least the source of product information; and
for each order, apply matching logic to determine whether the order qualifies for one or more of the plurality of cross-sell products; and
if the order qualifies, presenting the one or more qualifying cross-sell products to the user, whereby the user avoids a burden of manually identifying the one or more qualifying cross-sell products; and
(d) a pricing engine configured to calculate a price of the computer system in the configured state.

25. The system of claim 24, wherein each of the one or more qualifying cross-sell products presented to the user is offered at a discount based on the state of the system.

26. The system of claim 24, wherein the source of product information and the source of cross-sell product information are the same information source.

27. The system of claim 24, wherein the source of product information and the source of cross-sell product information comprises product data and associated logic relating the product data to each other.

28. The system of claim 24, further comprising wherein applying matching logic comprises determining whether the order satisfies predefined conditions.

29. The system of claim 24, further comprising a graphical user interface configured to display available selections from each of the source of product information and the source of cross-sell product information and further configured to present the one or more qualifying cross-sell products to the user.

30. The system of claim 29, wherein the graphical user interface comprises a selectable graphical element for invoking a configuration wizard adapted to facilitate adding the one or more qualifying cross-sell products to the computer system.

31. The system of claim 24, further comprising a configuration tool adapted to:
receive, from the user, the user selections from at least the source of product information;
configure the user selections to represent the configured state of the computer system based on the user selections;
for each user selection, output the order representing the configured state of the computer system.

32. The system of claim 31, wherein the configuration tool is further adapted to validate the state of the computer system to ensure that the individual products selected by the user are compatible and to ensure that the computer system is properly configured with products necessary for proper operation.
